(19) United States
(12) Patent Application Publication
(10) Pub. No.: US 2024/0363910 A1
(43) Pub. Date: Oct. 31, 2024

(54) ELECTROCHEMICAL DEVICE AND ELECTRONIC DEVICE CONTAINING SAME

(71) Applicant: Ningde Amperex Technology Limited, Ningde (CN)

(72) Inventors: Lilan ZHANG, Ningde (CN); Chao TANG, Ningde (CN)

(73) Assignee: Ningde Amperex Technology Limited, Ningde (CN)

(21) Appl. No.: 18/768,551

(22) Filed: Jul. 10, 2024

Related U.S. Application Data
(63) Continuation of application No. PCT/CN2022/070918, filed on Jan. 10, 2022.

(51) Int. Cl. H01M 10/42; H01M 4/02; H01M 4/131; H01M 10/0525; H01M 10/0567; H01M 10/0568

(52) U.S. Cl. CPC H01M 10/4235; H01M 4/131; H01M 10/0525; H01M 10/0567; H01M 10/0568; H01M 2004/028; H01M 2300/0025

(57) ABSTRACT

An electrochemical device includes a positive electrode and an electrolyte. The positive electrode includes a positive current collector and a positive electrode material layer disposed on at least one surface of the positive current collector. After the electrochemical device is charged and discharged for a first cycle, a number of pores in any one region of a 20 μm×20 μm size on the positive current collector is X, where X is an integer ranging from 0 to 10. The electrolyte includes a fluorine-containing sulfonyl imide salt and a fluorine-containing substance Y. Based on a mass of the electrolyte, a mass percent of the fluorine-containing sulfonyl imide salt is A %, and a mass percent of the fluorine-containing substance Y is B %. X, A, and B satisfy: 0≤AX/B≤450.

### CROSS REFERENCE TO THE RELATED APPLICATIONS

This application is a continuation under 35 U.S.C. § 120 of international patent application PCT/CN2022/070918 filed on Jan. 10, 2022, the entire content of which is incorporated herein by reference.

### TECHNICAL FIELD

This application relates to the technical field of electrochemistry, and in particular, to an electrochemical device and an electronic device containing the electrochemical device.

### BACKGROUND

By virtue of a high energy storage density, a high open-circuit voltage, a low self-discharge rate, a long cycle life, and other advantages, electrochemical devices (such as a lithium-ion battery) are widely used in various fields such as electrical energy storage, mobile electronic devices, electric vehicles, and aerospace equipment. As mobile electronic devices and electric vehicles enter a high-speed development stage, the market is imposing higher requirements on the cycle performance, safety performance, and other performance metrics of lithium-ion batteries.

However, currently, the safety performance of the lithium-ion batteries is improved usually at cost to cycle performance. Therefore, how to improve the cycle performance of a lithium-ion battery while improving the safety performance thereof becomes a pressing technical challenge to a person skilled in the art.

### SUMMARY

This application provides an electrochemical device and an electronic device containing the electrochemical device, so as to improve the cycle performance in addition to the safety performance of the electrochemical device.

It is hereby noted that in the subject-matter hereof, this application is construed by using a lithium-ion battery as an example of an electrochemical device, but the electrochemical device according to this application is not limited to the lithium-ion battery. Specific technical solutions are as follows:

A first aspect of this application provides an electrochemical device. The electrochemical device includes a positive electrode and an electrolyte. The positive electrode includes a positive current collector and a positive electrode material layer disposed on at least one surface of the positive current collector. After the electrochemical device is charged and discharged for a first cycle, a number of pores in any one region of a 20 μm×20 μm size on the positive current collector is X, where X is an integer ranging from 0 to 10. The electrolyte includes a fluorine-containing sulfonyl imide salt and a fluorine-containing substance Y Based on a mass of the electrolyte, a mass percent of the fluorine-containing sulfonyl imide salt is A %, and a mass percent of the fluorine-containing substance Y is B %. X, A, and B satisfy: 0≤AX/B≤450, preferably 0.25≤AX/B≤17. For example, the value of X may be 0, 1, 2, 3, 4, 5, 6, 7, 8, 9, or 10. The value of the AX/B ratio may be 0, 0.25, 0.28, 0.4, 0.57, 0.66, 1.1, 1.6, 1.97, 2, 2.76, 5, 5.33, 7.66, 10, 12, 14, 16.9, 100, 200, 300, 400, 416, 450, or a value falling within a range formed by any two thereof. By defining the relationship between X, A, and B to fall within the above range, the risk of corrosion caused by the electrolyte to the positive electrode collector is reduced, the number of pores in any region on the positive electrode collector is reduced, and the safety performance of the electrochemical device is improved. In addition, in the electrolyte of this application, the fluorine-containing sulfonyl imide salt and the fluorine-containing substance Y work synergistically to effectively improve the cycle performance of the electrochemical device. In this way, the electrochemical device is improved in terms of cycle performance in addition to safety performance.

In this application, a “pore” means a hollow with a depth greater than 50 nm and a maximum inner diameter greater than 200 nm on the positive current collector.

In some embodiments of this application, the positive current collector is an aluminum foil.

In some embodiments of this application, A satisfies: 1≤A≤25, preferably 10≤A≤25. For example, the value of A may be 1, 5, 10, 11, 13, 15, 17, 19, 21, 23, 25, or a value falling within a range formed by any two thereof. When the value of A is overly small (for example, less than 1), the mass percent of the fluorine-containing sulfonyl imide salt is overly low, and the cycle performance of the electrochemical device is not improved significantly. When the value of A is overly large (for example, greater than 25), the mass percent of the fluorine-containing sulfonyl imide salt is overly high, the risk of corrosion caused by the electrolyte to the positive current collector is increased, and the cycle performance and safety performance of the electrochemical device are impaired. Controlling the value of A to fall within the above range is more conducive to improving the cycle performance in addition to the safety performance of the electrochemical device.

In some embodiments of this application, the value of B satisfies: 0.5≤B≤40, preferably 15≤B≤35. For example, the value of B may be 0.5, 5, 10, 15, 17, 20, 22, 25, 28, 30, 32, 35, or a value falling within a range formed by any two thereof. When the value of B is overly small (for example, less than 0.5), the mass percent of the fluorine-containing substance Y is overly low, and the cycle performance and safety performance of the electrochemical device are not improved significantly. With the increase of the value of B, the mass percent of the fluorine-containing substance Y increases, the number of pores on the positive current collector is reduced, and the cycle performance and safety performance of the electrochemical device are improved. However, when the value of B exceeds 30, the number of pores on the positive current collector shows a tendency to increase, and the cycle performance and safety performance of the electrochemical device show a tendency to deteriorate. Therefore, controlling the value of B to fall within the above range is more conducive to improving the cycle performance in addition to the safety performance of the electrochemical device.

In some embodiments of this application, the fluorine-containing sulfonyl imide salt includes at least one of lithium bis(fluorosulfonyl)imide or lithium bis(trifluorosulfonyl)imide. The above types of fluorine-containing sulfonyl imide salt are more conducive to improving the cycle performance in addition to the safety performance of the electrochemical device.

In some embodiments of this application, the fluorine-containing substance Y includes at least one of fluorinated carboxylate ester, fluorinated carbonate ester, a fluorinated ether compound, a fluorinated phosphate ester, a fluorinated phosphite ester, a fluorinated sulfonate ester, a fluorinated borate ester, or a fluorinated anhydride; and/or the fluorine-containing substance Y includes at least one of fluorobenzene, lithium tetrafluoroborate, lithium difluorooxalate, lithium difluorophosphate, lithium trifluoromethylsulfonate, lithium difluoro(oxalato)borate, trifluoromethyl maleic anhydride, fluoroethylene sulfate, trifluoromethyl ethylene carbonate, or lithium 4,5-dicyano-2-(trifluoromethyl)imidazole.

Preferably, the fluorinated carboxylate ester includes at least one of ethyl monofluoroacetate, ethyl difluoroacetate, ethyl trifluoroacetate, ethyl fluoroacetate, 2,2,2-trifluoroethyl acetate, methyl fluoroacetate, ethyl fluoropropionate, 2,2,2-trifluoroethyl trifluoroacetate, methyl trifluoroacetate, ethyl 2,2-difluoropropionate, butyl fluoroacetate, methyl difluoroacetate, 2,2-difluoroethyl acetate, methyl 2-fluoroisobutyrate, ethyl 3-fluoropropionate, 2,2,2-trifluoroethyl n-butyrate, ethyl pentafluoropropionate, ethyl 3,3,3-trifluoropropionate, or 2,2,3,3-tetrafluoropropyl trifluoroacetate; the fluorinated carbonate ester includes at least one of bis(2,2,2-trifluoroethyl)carbonate, 2,2,3,3-tetrafluoropropyl methyl carbonate, bis(2,2,2-trifluoroethyl)carbonate, 2,2,3,3,3-pentafluoropropyl ethyl carbonate, ethyl trifluoroethyl carbonate, or fluoroethylene carbonate; the fluorinated ether compound includes at least one of 2,2,3,3-tetrafluoro-1-methoxypropane, bis(2,2-difluoroethyl)ether, 2,2-difluoroethyl methyl ether, 1,1,2,2-tetrafluoroethyl-2,2,3,3-tetrafluoropropyl ether, ethyl 1,1,2,3,3,3-hexafluoropropyl ether, 1,1,1,2,3,3-hexafluoro-3-methoxypropane, 1,1,2,3,3,3-hexafluoropropyl difluoromethyl ether, 2,2,3,3,3-pentafluoropropyl-1,1,2,2-tetrafluoroethyl, 2,2,3,3-tetrafluoropropyl difluoromethyl ether, perfluorobutyl methyl ether, methyl 2,2,3,3,3-pentafluoropropyl ether, 1-(1,1,2,2-tetrafluoroethoxy)butane, 2,2,3,3-tetrafluoro-1-methoxypropane, difluoromethyl-2,2,2-trifluoroethyl ether, 1-(1,1,2,2-tetrafluoroethoxy)propane, 1,3-bis(1,1,2,2-tetrafluoroethoxy)propane, 1-(2,2-difluoroethoxy)-1,1-difluoroethane, tetrafluoroethyl tetrafluoropropyl ether, or hexafluoropropyl ethyl ether; the fluorinated phosphate ester includes at least one of tris(2,2,2-trifluoroethyl)phosphate, or tris(2,2-difluoroethyl)phosphate; the fluorinated phosphite ester includes at least one of tris(2,2,2-trifluoroethyl)phosphite or tris(2,2-difluoroethyl)phosphite; the fluorinated sulfonate ester includes at least one of trifluoromethyl trifluoromethanesulfonate, 2,2,2-trifluoroethyl methanesulfonate, 2,2-difluoroethanol methanesulfonate, trifluoroethyl perfluorobutylsulfonate, 4-methoxycyclohexanol, 4,4,5,5,5-pentafluoropentyl methanesulfonate, 1,1,2,2,3,3,4,4,4-nonafluorobutane-1-sulfonate 2,2,2-trifluoro-1-trifluoromethyl ethyl ester, 1,1,1-trifluoropropane-2-yl trifluoromethanesulfonate, 1,1,2,2,3,3,4,4,4-nonafluoro-1-butanesulfonate 2,2-difluoroethyl ester, or 3,3,3-trifluoropropyl methanesulfonate; the fluorinated borate ester includes at least one of tris(hexafluoroisopropyl)borate ester or tris(trifluoroacetate)borane; and the fluorinated anhydride includes at least one of trifluoroacetic anhydride, difluoroacetic anhydride, tetrafluorophthalic anhydride, 4-fluorophthalic anhydride, tetrafluorosuccinic anhydride, heptafluorobutyric anhydride, hexafluoroglutaric anhydride, 4,5-difluorophthalic anhydride, perfluoropropionic anhydride, 4-trifluoromethylbenzoic anhydride, 3,6-difluorophthalic anhydride, 2,3,4,5,6-pentafluorobenzoic anhydride, or difluoromaleic anhydride.

The above types of fluorine-containing substance Y are more conducive to improving the cycle performance in addition to the safety performance of the electrochemical device.

In some embodiments of this application, the positive current collector includes a first element. The first element includes at least one of silicon, copper, manganese, iron, zinc, magnesium, titanium, or vanadium. Based on a mass of the positive current collector, a mass percent of the first element is C %, satisfying: 0<C<2. For example, the value of C may be 0.5, 0.8, 1.0, 1.5, 1.7, 1.9, or a value falling within a range formed by any two thereof. When the positive current collector includes the above types of first element and the mass percent of the first element is controlled to fall within the above range, the electrochemical device is further improved in terms of cycle performance in addition to safety performance. In this application, the type and mass percent of the first element of the positive current collector are related to the material of the positive current collector.

In some embodiments of this application, a mass percent of the fluorine-containing sulfonyl imide salt and a mass percent of the first element satisfy: 0<C/A<1.5. For example, the value of the C/A ratio may be 0.1, 0.16, 0.2, 0.3, 0.4, 0.46, 1.0, 1.2, 1.4, or a value falling within a range formed by any two thereof. Controlling the value of the C/A ratio to fall within the above range is more conducive to improving the cycle performance in addition to the safety performance of the electrochemical device.

In some embodiments of this application, a tensile strength F of the positive current collector, denoted as F N/mm², and the number of pores in the region, satisfy: 0≤X/F<0.1. For example, the value of the X/F ratio may be 0, 0.025, 0.003, 0.006, 0.01, 0.02, 0.05, 0.09, or a value falling within a range formed by any two thereof. The increase in the tensile strength F of the positive current collector leads to a decrease in the number X of pores on the positive current collector. Controlling the value of the X/F ratio to fall within the above range is more conducive to improving the cycle performance in addition to the safety performance of the electrochemical device.

The value of the tensile strength F N/mm² of the positive current collector is not particularly limited herein, as long as the objectives of this application can be achieved. For example, F satisfies: 50<F≤420.

In some embodiments of this application, the electrolyte further includes an additive. The additive includes at least one of 1,3-propane sultone, 1,4-butane sultone, vinylene carbonate, succinonitrile, adiponitrile, 1,3,6-hexanetricarbonitrile, 1,2,3-tri(2-cyanooxy)propane, ethylene glycol bis(propionitrile)ether, or fumaronitrile. When the electrolyte includes the above types of additives, a solid electrolyte interphase (SEI) film is more favorably formed on the surface of the positive electrode and/or the surface of the negative electrode to further enhance the stability of a cathode electrolyte interface and an anode electrolyte interface, thereby improving the cycle performance in addition to the safety performance of the electrochemical device.

In some embodiments of this application, based on the mass of the electrolyte, a mass percent W_{T} of the additive is 0.5% to 3%. For example, the mass percent W_{T} of the additive may be 0.5%, 1%, 1.5%, 2%, 2.5%, 3%, or a value falling within a range formed by any two thereof. Controlling the mass percent W_{T} of the additive to fall within the above range is more conducive to improving the cycle performance in addition to the safety performance of the electrochemical device.

The electrolyte in this application may further include a lithium salt and a nonaqueous solvent. The type of the lithium salt is not particularly limited herein, as long as the objectives of this application can be achieved. For example, the lithium salt may be lithium hexafluorophosphate (LiPF₆). The mass percent of the lithium salt in the electrolyte is not particularly limited herein, and may be controlled by a person skilled in the art in view of the mass percent of the fluorine-containing sulfonyl imide salt, as long as the objectives of this application can be achieved. The nonaqueous solvent is not particularly limited herein, as long as the objectives of this application can be achieved. For example, the nonaqueous solvent may include at least one of a carbonate ester compound, a carboxylate ester compound, an ether compound, or another organic solvent. The carbonate ester compound may include at least one of a chain carbonate ester compound, a cyclic carbonate ester compound, or a fluorocarbonate ester compound. The chain carbonate ester compound may include at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate ester compound may include at least one of ethylene carbonate (EC), propylene carbonate (PC), butylene carbonate (BC), or vinyl ethylene carbonate (VEC). The fluorocarbonate ester compound may include at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include at least one of methyl formate, methyl acetate, ethyl acetate, n-propyl acetate, tert-butyl acetate, methyl propionate, ethyl propionate, propyl propionate, γ-butyrolactone, decanolactone, valerolactone, mevalonolactone, or caprolactone. The ether compound may include at least one of dibutyl ether, tetraglyme, diglyme, 1,2-dimethoxyethane, 1,2-diethoxyethane, ethoxy-methoxyethane, 2-methyltetrahydrofuran, or tetrahydrofuran. The other organic solvent may include at least one of dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, or phosphate ester. Based on the mass of the electrolyte, a total mass percent of the nonaqueous solvent is 5% to 60%, for example, 5%, 10%, 15%, 20%, 25%, 30%, 35%, 40%, 45%, 50%, 55%, 60%, or a value falling within a range formed by any two thereof.

The positive electrode material layer in this application includes a positive active material. The positive active material is not particularly limited herein, as long as the objectives of this application can be achieved. For example, the positive active material includes at least one of lithium nickel cobalt manganese oxide (811, 622, 523, 111), lithium nickel cobalt aluminum oxide, lithium iron phosphate, a lithium-rich manganese-based material, lithium cobalt oxide (LiCoO₂), lithium manganese oxide, lithium manganese iron phosphate, or lithium titanium oxide.

The thicknesses of the positive current collector and the positive electrode material layer are not particularly limited herein, as long as the objectives of this application can be achieved. For example, the thickness of the positive current collector is 5 μm to 20 μm, preferably 6 μm to 18 μm. The thickness of the positive electrode material layer is 30 μm to 500 km. Optionally, the positive electrode may further include a conductive agent and a binder.

The electrochemical device of this application further includes a negative electrode. The negative electrode is not particularly limited herein, as long as the objectives of this application can be achieved. For example, the negative electrode includes a negative current collector and a negative electrode material layer. The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector, or the like. The negative electrode material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x<2), or metallic lithium. The thicknesses of the negative current collector and the negative electrode material layer are not particularly limited herein, as long as the objectives of this application can be achieved. For example, the thickness of the negative current collector is 4 μm to 20 μm, and the thickness of the negative electrode material layer is 30 μm to 300 μm. Optionally, the negative electrode may further include a conductive agent and a binder.

The conductive agent is not particularly limited as long as the objectives of this application can be achieved. For example, the conductive agent may include at least one of conductive carbon black (Super P), carbon nanotubes (CNTs), carbon nanofibers, flake graphite, acetylene black, carbon black, Ketjen black, carbon dots, carbon nanotubes, or graphene. For example, the binder may include at least one of polypropylene alcohol, sodium polyacrylate, potassium polyacrylate, lithium polyacrylate, polyimide, polyamide imide, styrene butadiene rubber (SBR), polyvinyl alcohol (PVA), polyvinylidene fluoride, polyvinylidene difluoride (PVDF), polytetrafluoroethylene (PTFE), polyvinyl butyral (PVB), water-based acrylic resin, carboxymethyl cellulose (CMC), or sodium carboxymethyl cellulose (CMC-Na).

The electrochemical device in this application further includes a separator. The separator is not particularly limited herein, as long as the objectives of this application can be achieved. For example, the separator may include a substrate layer and a surface treatment layer. The substrate layer may be a non-woven fabric, film or composite film, which, in each case, is porous. The material of the substrate layer may include at least one of polyethylene, polypropylene, polyethylene terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is disposed on at least one surface of the substrate layer. The surface treatment layer may be a polymer layer or an inorganic compound layer, or a layer compounded of a polymer and an inorganic compound. For example, the inorganic compound layer includes inorganic particles and a binder. The inorganic particles are not particularly limited, and may be at least one selected from: aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, and exemplarily, may be at least one selected from polyvinylidene difluoride, poly(vinylidene difluoride-co-hexafluoropropylene), polyamide, polyacrylonitrile, polyacrylate, polyacrylic acid, polyacrylic acid sodium salt, polyvinylpyrrolidone, polyvinyl ether, poly methyl methacrylate, polytetrafluoroethylene, or polyhexafluoropropylene. The polymer layer includes a polymer, and the material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene difluoride-co-hexafluoropropylene).

The electrochemical device in this application is not particularly limited, and may be any device in which an electrochemical reaction occurs. In some embodiments, the electrochemical device may include, but not limited to, a lithium metal secondary battery, a lithium-ion battery, a lithium polymer secondary battery, a lithium-ion polymer secondary battery, or the like.

The process of preparing the electrochemical device is well known to a person skilled in the art, and is not particularly limited herein. For example, the preparation process may include, but without being limited to, the following steps: stacking the positive electrode, the separator, and the negative electrode in sequence, and performing operations such as winding and folding as required to obtain a jelly-roll electrode assembly; putting the electrode assembly into a packaging shell, injecting the electrolyte into the packaging shell, and sealing the packaging shell to obtain an electrochemical device; or, stacking the positive electrode, the separator, and the negative electrode in sequence, and then fixing the four corners of the entire stacked structure by use of adhesive tape to obtain a stacked-type electrode assembly, putting the electrode assembly into a packaging shell, injecting the electrolyte into the packaging shell, and sealing the packaging shell to obtain an electrochemical device. In addition, an overcurrent prevention element, a guide plate, and the like may be placed into the packaging shell as required, so as to prevent the rise of internal pressure, overcharge, and overdischarge of the electrochemical device.

A second aspect of this application provides an electronic device. The electronic device includes the electrochemical device disclosed in any one of the above embodiments. Therefore, the electronic device exhibits good cycle performance in addition to good safety performance.

The electronic devices of this application are not particularly limited, and may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, and the like.

This application provides an electrochemical device and an electronic device containing same. The electrochemical device includes a positive electrode and an electrolyte. The positive electrode includes a positive current collector and a positive electrode material layer disposed on at least one surface of the positive current collector. After the electrochemical device is charged and discharged for a first cycle, a number of pores in any one region of a 20 μm×20 μm size on the positive current collector is X, where X is an integer ranging from 0 to 10. The electrolyte includes a fluorine-containing sulfonyl imide salt and a fluorine-containing substance Y Based on a mass of the electrolyte, a mass percent of the fluorine-containing sulfonyl imide salt is A %, and a mass percent of the fluorine-containing substance Y is B %. X, A, and B satisfy: 0≤AX/B≤450. By defining the relationship between X, A, and B to fall within the above range, the risk of corrosion caused by the electrolyte to the positive electrode collector is reduced, the number of pores in any region on the positive electrode collector is reduced, and the safety performance of the electrochemical device is improved. In addition, in the electrolyte of this application, the fluorine-containing sulfonyl imide salt and the fluorine-containing substance Y work synergistically to effectively improve the cycle performance of the electrochemical device. In this way, the electrochemical device is improved in terms of cycle performance in addition to safety performance.

### DETAILED DESCRIPTION

To make the objectives, technical solutions, and advantages of this application clearer, the following describes this application in more detail with reference to embodiments. Evidently, the described embodiments are merely a part of but not all of the embodiments of this application. All other embodiments derived by a person of ordinary skill in the art based on the embodiments of this application fall within the protection scope of this application.

### EMBODIMENTS

The implementations of this application are described below in more detail with reference to embodiments and comparative embodiments. Various tests and evaluations are performed by the following methods.

### Test Methods and Devices

### Testing the Number of Pores X:

Disassembling a lithium-ion battery that has been charged and discharged for a first cycle, and placing a positive current collector of the battery into a scanning electron microscope (SEM) for observing the microstructure.

Recording the number of pores in any one region of a 20 μm×20 μm size on the positive current collector, denoted as X.

### Testing the First Element:

Mixing 5 ml of aqua regia and 5 ml of deionized water to form a solution. Placing the solution into a beaker. Immersing, in the above solution, 0.2 gram of the positive current collector (not coated with a positive electrode slurry) from each embodiment and each comparative embodiment. Leaving the positive current collector to completely dissolve to form a mixed solution, and diluting the mixed solution with water until the volume is 50 ml. Testing the type and mass percent of the first element by using an inductively coupled plasma (ICP) optical emission spectrometer.

### Testing the Tensile Strength F of a Positive Current Collector:

Cutting the positive current collector in each embodiment and each comparative embodiment into a strip specimen with a length of 200±0.5 mm and a width of 15±0.25 mm. Fixing the strip specimen to both ends of a tensile testing machine. Setting the tensile speed of the tensile testing machine to 50 mm/min, and setting a distance between two grippers of a jig of the tensile testing machine to 125±0.1 mm. Testing the specimens in groups, each group containing 5 parallel specimens from each embodiment or each comparative embodiment. Using an average value of the five measured values as a test result. Letting the length direction of the specimen be parallel to the axis of the jig, keeping the specimen rectilinear, and carrying out the test at a temperature of 20±5° C.

### Testing the Cycle Performance:

Charging a lithium-ion battery at 45° C. at a constant current of 1 C until the voltage reaches 4.45 V, leaving the battery to stand for 30 minutes, and then discharging the battery at a constant current of 1 C until the voltage reaches 3.0 V, thereby completing 1 cycle of charge and discharge. Recording the discharge capacity at this time as a first-cycle discharge capacity C₀. Repeating the above charging and discharging steps for 500 cycles, and recording a discharge capacity at the end of the 500^{th} cycle as a 500^{th}-cycle discharge capacity C₅₀₀.

Characterizing the cycle performance by using a cycle capacity retention rate: Cycle capacity retention rate (%)=C₅₀₀/C₀×100%.

### Testing the Safety Performance:

Placing a lithium-ion battery subjected to 45° C. high-temperature cycling into a 25° C. thermostat. Charging the battery at a constant current of 0.5 C until the voltage reaches 4.45 V, and then charging the battery at a constant voltage until the current drops to 0.05 C. Placing the lithium-ion battery in a 25° C. environment, and performing a drop test. Dropping the lithium-ion battery from a height of 1 m onto a concrete floor. Dropping 1 lithium-ion battery for 3 times, in which different parts of the battery hit the concrete floor randomly. Testing the batteries in group, each group containing 20 lithium-ion batteries. It is determined that a lithium-ion battery fails the test if electrolyte leakage, fire, or explosion occurs in the battery.

Characterizing the safety performance by using a drop pass rate: Drop pass rate (%)=the number of failed lithium-ion batteries/20×100%.

### Embodiment 1-1

### <Preparing an Electrolyte>

Mixing EC, PC, and DEC at a mass ratio of 30:10:60 in a dry argon atmosphere to obtain a base solvent, and adding lithium bis(fluorosulfonyl)imide as a fluorine-containing sulfonyl imide salt and lithium difluoro(oxalato)borate as a fluorine-containing substance Y into the base solvent to obtain an electrolyte. Based on the mass of the electrolyte, a mass percent of the fluorine-containing sulfonyl imide salt is A %=10%, a mass percent of the fluorine-containing substance Y is B %=3%, and the rest is the base solvent.

### <Preparing a Positive Electrode>

Mixing LiCoO₂ as a positive active material, PVDF as a binder, Super P as a conductive agent at a mass ratio of 96:2:2, adding N-methyl-pyrrolidone (NMP), and stirring well with a vacuum mixer to obtain a positive electrode slurry in which the solid content is 70 wt %. Coating one surface of a 12 μm-thick positive current collector aluminum foil with the positive electrode slurry evenly, and drying the slurry at 120° C. for 1 hour to obtain a positive electrode coated with a positive electrode material layer on a single side. Repeating the above steps on the other surface of the aluminum foil to obtain a positive electrode coated with the positive electrode material layer on both sides. Subsequently, performing cold-pressing, cutting, and slitting to obtain a positive electrode of 74 mm×867 mm in size.

### <Preparing a Negative Electrode>

Mixing SiO and graphite (the mass ratio between the SiO and the graphite is 1:9) to form a negative active material, mixing the negative active material with carboxymethyl cellulose (CMC) and styrene-butadiene rubber (SBR) at a mass ratio of 85:2:13, adding deionized water, and stirring well with a vacuum mixer to obtain a negative electrode slurry in which the solid content is 75 wt %. Coating one surface of a 12 μm-thick negative current collector copper foil with the negative electrode slurry evenly, and drying the slurry at 120° C. for 1 hour to obtain a negative electrode coated with a 130 μm-thick negative electrode material layer on a single side. Repeating the above steps on the other surface of the copper foil to obtain a negative electrode coated with the negative electrode material layer on both sides. Subsequently, performing cold-pressing, cutting, and slitting to obtain a negative electrode of 75 mm×851 mm in size.

### <Preparing a Separator>

Using a 12 m-thick polypropylene film as a separator.

### <Preparing a Lithium-Ion Battery>

Stacking the prepared positive electrode, the separator, and the negative electrode sequentially in such a way that the separator is located between the positive electrode and the negative electrode to serve a function of separation, and winding the stacked structure to obtain an electrode assembly. Putting the electrode assembly into an aluminum laminated film packaging shell, dehydrating the packaged electrode assembly in an 85° C. vacuum oven for 12 hours, and then injecting the prepared electrolyte. Performing steps such as vacuum sealing, standing, chemical formation, degassing, and shaping to obtain a lithium-ion battery.

### Embodiments 1-2 to 1-10

Identical to Embodiment 1-1 except that the relevant preparation parameters are adjusted according to Table 1 and the mass percent of the base solvent varies with A % and B % based on the total mass 100% of the electrolyte.

### Embodiments 2-1 to 2-5

Identical to Embodiment 1-1 except that the relevant preparation parameters are adjusted according to Table 2.

### Embodiments 3-1 to 3-4

Identical to Embodiment 1-1 except that the mass percent A % of the fluorine-containing sulfonyl imide salt is adjusted, the mass percent of the base solvent is changed accordingly based on the total mass 100% of the electrolyte, and the type and mass percent C % of the first element are adjusted according to Table 3.

### Embodiments 4-1 to 4-4

Identical to Embodiment 3-4 except that the tensile strength F is adjusted so that the relevant preparation parameters are as shown in Table 4.

### Embodiments 5-1 to 5-6

Identical to Embodiment 4-3 except that, in <Preparing an electrolyte>, the specified types of additives are further added at the mass percent shown in Table 5, and the mass percent of the base solvent varies with the mass percent of the additives based on a total mass 100% of the electrolyte.

### Comparative Embodiments 1-1 to 1-2

Identical to Embodiment 1-1 except that the relevant preparation parameters are adjusted according to Table 1.

The relative preparation parameters and performance parameters of each embodiment and each comparative embodiment are shown in Table 1 to Table 5:

TABLE 1

| | | | | | Cycle | Safety |
|---|---|---|---|---|---|---|
| | | | | | perfor- | perfor- |
| | | | | | mance | mance |
| | A % | B % | X | AX/B | (%) | (%) |
| Embodiment 1-1 | 10 | 3 | 3 | 10 | 68 | 70 |
| Embodiments 1 to 2 | 10 | 15 | 1 | 0.66 | 70 | 80 |
| Embodiments 1 to 3 | 10 | 25 | 1 | 0.4 | 71 | 80 |
| Embodiments 1 to 4 | 10 | 35 | 1 | 0.28 | 72 | 80 |
| Embodiments 1 to 5 | 20 | 15 | 4 | 5.33 | 75 | 75 |
| Embodiments 1 to 6 | 20 | 25 | 2 | 1.6 | 75 | 80 |
| Embodiments 1 to 7 | 20 | 35 | 1 | 0.57 | 76 | 85 |
| Embodiments 1 to 8 | 23 | 15 | 5 | 7.66 | 76 | 75 |
| Embodiments 1 to 9 | 23 | 25 | 3 | 2.76 | 77 | 80 |
| Embodiments 1 to 10 | 23 | 35 | 3 | 1.97 | 78 | 80 |
| Embodiments 1 to 11 | 22.5 | 0.5 | 10 | 450 | 75 | 70 |
| Embodiments 1 to 12 | 1 | 0.5 | 1 | 2 | 65 | 85 |
| Comparative | 0.2 | 43 | 0 | 0 | 32 | 100 |
| Embodiment 1-1 | | | | | | |
| Comparative | 30 | 0.1 | 12 | 3600 | 60 | 45 |
| Embodiment 1-2 | | | | | | |

As can be seen from Embodiments 1-1 to 1-12 and Comparative Embodiments 1-1 and 1-2, the safety performance and cycle performance of the lithium-ion battery varies with the relationship denoted by AX/B, where X is the number of pores, A indicates the mass percent A % of the fluorine-containing sulfonyl imide salt, and B indicates the mass percent B % of the fluorine-containing substance Y With the value of the AX/B ratio falling within the range specified herein, the lithium-ion battery exhibits higher safety performance and cycle performance.

TABLE 2

| | | | Cycle | Safety |
|---|---|---|---|---|
| | Fluorine-containing substance Y | | performance | performance |
| | Type | B % | (%) | (%) |
| Embodiment 1-1 | Lithium difluoro(oxalato)borate | 3 | 70 | 80 |
| Embodiments 2 to 1 | Trifluoromethyl maleic anhydride | 3 | 71 | 80 |
| Embodiment 2-2 | Fluorinated ethylene sulfate | 3 | 72 | 80 |
| Embodiments 2 to 3 | Lithium tetrafluoroborate | 5 | 74 | 85 |
| Embodiments 2 to 4 | Trifluoromethyl ethylene carbonate | 5 | 71 | 80 |
| Embodiments 2 to 5 | Fluorobenzene | 5 | 70 | 85 |

The type of the fluorine-containing substance Y usually also affects the safety performance and cycle performance of the lithium-ion battery. As can be seen from Embodiment 1-1 and Embodiments 2-1 to 2-5, when the type of the fluorine-containing substance Y falls within the range specified herein, the lithium-ion battery exhibits good cycle performance in addition to good safety performance.

TABLE 3

| | | | | | Cycle | Safety |
|---|---|---|---|---|---|---|
| | | | | | perfor- | perfor- |
| | | First element | | | mance | mance |
| | A % | Type | C % | C/A | (%) | (%) |
| Embodiments 3 to 1 | 5 | Mg | 0.5 | 0.1 | 69 | 85 |
| Embodiments 3 to 2 | 5 | Mg | 1.0 | 0.2 | 71 | 85 |
| Embodiment 3-3 | 5 | Mg | 1.9 | 0.38 | 70 | 80 |
| Embodiments 3 to 4 | 1.1 | Mg | 1.5 | 1.4 | 69 | 83 |

The mass percent C % of the first element, and the ratio (C/A) of the mass percent C % of the first element to the mass percent A % of the fluorine-containing sulfonyl imide salt, usually also affect the safety performance and cycle performance of the lithium-ion battery. As can be seen from Embodiments 3-1 to 3-4, when the mass percent C % of the first element and the ratio (C/A) of the mass percent C % of the first element to the mass percent A % of the fluorine-containing sulfonyl imide salt fall within the ranges specified herein, the lithium-ion battery exhibits good cycle performance in addition to good safety performance.

TABLE 4

| | | | | Cycle | Safety |
|---|---|---|---|---|---|
| | F | | | performance | performance |
| | (N/mm²) | X | X/F | (%) | (%) |
| Embodiments 4 to 1 | 400 | 1 | 0.025 | 70 | 100 |
| Embodiments 4 to 2 | 300 | 1 | 0.003 | 70 | 100 |
| Embodiments 4 to 3 | 150 | 1 | 0.006 | 69 | 100 |
| Embodiment 4-4 | 420 | 0 | 0 | 68 | 100 |

The ratio of the number X of pores to the tensile strength F of the positive current collector, denoted as X/F, usually also affects the safety performance and cycle performance of the lithium-ion battery. As can be seen from Embodiments 4-1 to 4-4, when the ratio (X/F) of the number X of pores to the tensile strength F of the positive current collector falls within the range specified herein, the lithium-ion battery exhibits good cycle performance in addition to good safety performance.

TABLE 5

| | | | Cycle | Safety |
|---|---|---|---|---|
| | | W_{T} | performance | performance |
| | Type of additive | (%) | (%) | (%) |
| Embodiments 4 to 3 | \ | \ | 69 | 100 |
| Embodiments 5 to 1 | Vinylene carbonate | 0.5 | 78 | 100 |
| Embodiments 5 to 2 | Succinonitrile | 1 | 83 | 100 |
| Embodiments 5 to 3 | Adiponitrile | 1 | 81 | 100 |
| Embodiments 5 to 4 | 1,3,6- | 1 | 83 | 100 |
| | hexanetricarbonitrile | | | |
| Embodiment 5-5 | 1,3-propane sultone + | 0.5 + 1 | 80 | 100 |
| | vinylene carbonate | | | |
| Embodiments 5 to 6 | Vinylene carbonate + | 1 + 1 + 1 | 89 | 100 |
| | 1,3,6- | | | |
| | hexanetricarbonitrile + | | | |
| | succinonitrile | | | |

Note:
“\” in Table 5 indicates absence of the corresponding preparation parameter.

The type and mass percent W_{T} of the additives in the electrolyte usually also affect the safety performance and cycle performance of the lithium-ion battery. As can be seen from Embodiment 4-3 and Embodiments 5-1 to 5-6, when the type and mass percent W_{T} of the additives fall within the ranges specified herein, the lithium-ion battery exhibits good cycle performance in addition to good safety performance.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. An electrochemical device, comprising a positive electrode and an electrolyte; wherein
the positive electrode comprises a positive current collector and a positive electrode material layer disposed on at least one surface of the positive current collector;
a number of pores in any one region of a 20 μm×20 μm size on the positive current collector is X, wherein X is an integer ranging from 0 to 10;
the electrolyte comprises a fluorine-containing sulfonyl imide salt and a fluorine-containing substance Y; based on a mass of the electrolyte, a mass percent of the fluorine-containing sulfonyl imide salt is A %, and a mass percent of the fluorine-containing substance Y is B %; and
$$0 \leq AX / B \leq 450 .$$

2. The electrochemical device according to claim 1, wherein 1≤A≤25.

3. The electrochemical device according to claim 2, wherein 0.5≤B≤40.

4. The electrochemical device according to claim 1, wherein the fluorine-containing sulfonyl imide salt comprises at least one of lithium bis(fluorosulfonyl)imide or lithium bis(trifluorosulfonyl)imide.

5. The electrochemical device according to claim 1, wherein the fluorine-containing substance Y comprises at least one of fluorinated carboxylate ester, fluorinated carbonate ester, a fluorinated ether compound, a fluorinated phosphate ester, a fluorinated phosphite ester, a fluorinated sulfonate ester, a fluorinated borate ester, or a fluorinated anhydride; and/or
the fluorine-containing substance Y comprises at least one of fluorobenzene, lithium tetrafluoroborate, lithium difluorooxalate, lithium difluorophosphate, lithium trifluoromethylsulfonate, lithium difluoro(oxalato)borate, trifluoromethyl maleic anhydride, fluoroethylene sulfate, trifluoromethyl ethylene carbonate, or lithium 4,5-dicyano-2-(trifluoromethyl)imidazole.

6. The electrochemical device according to claim 5, wherein the fluorinated carboxylate ester comprises at least one of ethyl monofluoroacetate, ethyl difluoroacetate, ethyl trifluoroacetate, 2,2,2-trifluoroethyl acetate, methyl fluoroacetate, ethyl fluoropropionate, 2,2,2-trifluoroethyl trifluoroacetate, methyl trifluoroacetate, ethyl 2,2-difluoropropionate, butyl fluoroacetate, methyl difluoroacetate, 2,2-difluoroethyl acetate, methyl 2-fluoroisobutyrate, ethyl 3-fluoropropionate, 2,2,2-trifluoroethyl n-butyrate, ethyl pentafluoropropionate, ethyl 3,3,3-trifluoropropionate, or 2,2,3,3-tetrafluoropropyl trifluoroacetate;
the fluorinated carbonate ester comprises at least one of bis(2,2,2-trifluoroethyl)carbonate, 2,2,3,3-tetrafluoropropyl methyl carbonate, bis(2,2,2-trifluoroethyl)carbonate, 2,2,3,3,3-pentafluoropropyl ethyl carbonate, ethyl trifluoroethyl carbonate, or fluoroethylene carbonate;
the fluorinated ether compound comprises at least one of 2,2,3,3-tetrafluoro-1-methoxypropane, bis(2,2-difluoroethyl)ether, 2,2-difluoroethyl methyl ether, 1,1,2,2-tetrafluoroethyl-2,2,3,3-tetrafluoropropyl ether, ethyl 1,1,2,3,3,3-hexafluoropropyl ether, 1,1,1,2,3,3-hexafluoro-3-methoxypropane, 1,1,2,3,3,3-hexafluoropropyl difluoromethyl ether, 2,2,3,3,3-pentafluoropropyl-1,1,2,2-tetrafluoroethyl, 2,2,3,3-tetrafluoropropyl difluoromethyl ether, perfluorobutyl methyl ether, methyl 2,2,3,3,3-pentafluoropropyl ether, 1-(1,1,2,2-tetrafluoroethoxy)butane, 2,2,3,3-tetrafluoro-1-methoxypropane, difluoromethyl-2,2,2-trifluoroethyl ether, 1-(1,1,2,2-tetrafluoroethoxy)propane, 1,3-bis(1,1,2,2-tetrafluoroethoxy)propane, 1-(2,2-difluoroethoxy)-1,1-difluoroethane, tetrafluoroethyl tetrafluoropropyl ether, or hexafluoropropyl ethyl ether;
the fluorinated phosphate ester comprises at least one of tris(2,2,2-trifluoroethyl)phosphate, or tris(2,2-difluoroethyl)phosphate;
the fluorinated phosphite ester comprises at least one of tris(2,2,2-trifluoroethyl)phosphite or tris(2,2-difluoroethyl)phosphite;
the fluorinated sulfonate ester comprises at least one of trifluoromethyl trifluoromethanesulfonate, 2,2,2-trifluoroethyl methanesulfonate, 2,2-difluoroethanol methanesulfonate, trifluoroethyl perfluorobutylsulfonate, 4-methoxycyclohexanol, 4,4,5,5,5-pentafluoropentyl methanesulfonate, 1,1,2,2,3,3,4,4,4-nonafluorobutane-1-sulfonate 2,2,2-trifluoro-1-trifluoromethyl-ethyl ester, 1,1,1-trifluoropropane-2-yl trifluoromethanesulfonate, 1,1,2,2,3,3,4,4,4-nonafluoro-1-butanesulfonate 2,2-difluoroethyl ester, or 3,3,3-trifluoropropyl methanesulfonate;
the fluorinated borate ester comprises at least one of tris(hexafluoroisopropyl)borate ester or tris(trifluoroacetate)borane; and
the fluorinated anhydride comprises at least one of trifluoroacetic anhydride, difluoroacetic anhydride, tetrafluorophthalic anhydride, 4-fluorophthalic anhydride, tetrafluorosuccinic anhydride, heptafluorobutyric anhydride, hexafluoroglutaric anhydride, 4,5-difluorophthalic anhydride, perfluoropropionic anhydride, 4-trifluoromethylbenzoic anhydride, 3,6-difluorophthalic anhydride, 2,3,4,5,6-pentafluorobenzoic anhydride, or difluoromaleic anhydride.

7. The electrochemical device according to claim 1, wherein the positive current collector comprises a first element; the first element comprises at least one of silicon, copper, manganese, iron, zinc, magnesium, titanium, or vanadium; and
based on a mass of the positive current collector, a mass percent of the first element is C %, and 0<C<2.

8. The electrochemical device according to claim 7, wherein 0<C/A<1.5.

9. The electrochemical device according to claim 1, wherein 0≤X/F<0.1, F N/mm² is a tensile strength of the positive current collector.

10. The electrochemical device according to claim 1, wherein the electrolyte further comprises an additive; and the additive comprises at least one of 1,3-propane sultone, 1,4-butane sultone, vinylene carbonate, succinonitrile, adiponitrile, 1,3,6-hexanetricarbonitrile, 1,2,3-tri(2-cyanooxy)propane, ethylene glycol bis(propionitrile)ether, or fumaronitrile.

11. The electrochemical device according to claim 10, wherein, based on the mass of the electrolyte, a mass percent of the additive is 0.5% to 3%.

12. The electrochemical device according to claim 3, satisfying at least one of the following characteristics:
$$0.25 < AX / B < 17 , \qquad ( i )$$
$$10 \leq A \leq 25 ; and \qquad ( ii )$$
$$15 \leq B \leq 35 . \qquad ( iii )$$

13. An electronic device, comprising an electrochemical device, the electrochemical device comprises a positive electrode and an electrolyte; wherein
the positive electrode comprises a positive current collector and a positive electrode material layer disposed on at least one surface of the positive current collector;
a number of pores in any one region of a 20 μm×20 μm size on the positive current collector is X, wherein X is an integer ranging from 0 to 10;
the electrolyte comprises a fluorine-containing sulfonyl imide salt and a fluorine-containing substance Y; based on a mass of the electrolyte, a mass percent of the fluorine-containing sulfonyl imide salt is A %, and a mass percent of the fluorine-containing substance Y is B %; and
$$0 ⩽ AX / B ⩽ 45 \; 0 .$$

14. The electronic device according to claim 13, wherein 1≤A≤25.

15. The electronic device according to claim 14, wherein 0.5≤B≤40.

16. The electronic device according to claim 13, wherein the fluorine-containing sulfonyl imide salt comprises at least one of lithium bis(fluorosulfonyl)imide or lithium bis(trifluorosulfonyl)imide.

17. The electronic device according to claim 13, wherein the fluorine-containing substance Y comprises at least one of fluorinated carboxylate ester, fluorinated carbonate ester, a fluorinated ether compound, a fluorinated phosphate ester, a fluorinated phosphite ester, a fluorinated sulfonate ester, a fluorinated borate ester, or a fluorinated anhydride; and/or
the fluorine-containing substance Y comprises at least one of fluorobenzene, lithium tetrafluoroborate, lithium difluorooxalate, lithium difluorophosphate, lithium trifluoromethylsulfonate, lithium difluoro(oxalato)borate, trifluoromethyl maleic anhydride, fluoroethylene sulfate, trifluoromethyl ethylene carbonate, or lithium 4,5-dicyano-2-(trifluoromethyl)imidazole.

18. The electronic device according to claim 17, wherein the fluorinated carboxylate ester comprises at least one of ethyl monofluoroacetate, ethyl difluoroacetate, ethyl trifluoroacetate, 2,2,2-trifluoroethyl acetate, methyl fluoroacetate, ethyl fluoropropionate, 2,2,2-trifluoroethyl trifluoroacetate, methyl trifluoroacetate, ethyl 2,2-difluoropropionate, butyl fluoroacetate, methyl difluoroacetate, 2,2-difluoroethyl acetate, methyl 2-fluoroisobutyrate, ethyl 3-fluoropropionate, 2,2,2-trifluoroethyl n-butyrate, ethyl pentafluoropropionate, ethyl 3,3,3-trifluoropropionate, or 2,2,3,3-tetrafluoropropyl trifluoroacetate;
the fluorinated carbonate ester comprises at least one of bis(2,2,2-trifluoroethyl)carbonate, 2,2,3,3-tetrafluoropropyl methyl carbonate, bis(2,2,2-trifluoroethyl)carbonate, 2,2,3,3,3-pentafluoropropyl ethyl carbonate, ethyl trifluoroethyl carbonate, or fluoroethylene carbonate;
the fluorinated ether compound comprises at least one of 2,2,3,3-tetrafluoro-1-methoxypropane, bis(2,2-difluoroethyl)ether, 2,2-difluoroethyl methyl ether, 1,1,2,2-tetrafluoroethyl-2,2,3,3-tetrafluoropropyl ether, ethyl 1,1,2,3,3,3-hexafluoropropyl ether, 1,1,1,2,3,3-hexafluoro-3-methoxypropane, 1,1,2,3,3,3-hexafluoropropyl difluoromethyl ether, 2,2,3,3,3-pentafluoropropyl-1,1,2,2-tetrafluoroethyl, 2,2,3,3-tetrafluoropropyl difluoromethyl ether, perfluorobutyl methyl ether, methyl 2,2,3,3,3-pentafluoropropyl ether, 1-(1,1,2,2-tetrafluoroethoxy)butane, 2,2,3,3-tetrafluoro-1-methoxypropane, difluoromethyl-2,2,2-trifluoroethyl ether, 1-(1,1,2,2-tetrafluoroethoxy)propane, 1,3-bis(1,1,2,2-tetrafluoroethoxy)propane, 1-(2,2-difluoroethoxy)-1,1-difluoroethane, tetrafluoroethyl tetrafluoropropyl ether, or hexafluoropropyl ethyl ether;
the fluorinated phosphate ester comprises at least one of tris(2,2,2-trifluoroethyl)phosphate, or tris(2,2-difluoroethyl)phosphate;
the fluorinated phosphite ester comprises at least one of tris(2,2,2-trifluoroethyl)phosphite or tris(2,2-difluoroethyl)phosphite;
the fluorinated sulfonate ester comprises at least one of trifluoromethyl trifluoromethanesulfonate, 2,2,2-trifluoroethyl methanesulfonate, 2,2-difluoroethanol methanesulfonate, trifluoroethyl perfluorobutylsulfonate, 4-methoxycyclohexanol, 4,4,5,5,5-pentafluoropentyl methanesulfonate, 1,1,2,2,3,3,4,4,4-nonafluorobutane-1-sulfonate 2,2,2-trifluoro-1-trifluoromethyl-ethyl ester, 1,1,1-trifluoropropane-2-yl trifluoromethanesulfonate, 1,1,2,2,3,3,4,4,4-nonafluoro-1-butanesulfonate 2,2-difluoroethyl ester, or 3,3,3-trifluoropropyl methanesulfonate;
the fluorinated borate ester comprises at least one of tris(hexafluoroisopropyl)borate ester or tris(trifluoroacetate)borane; and
the fluorinated anhydride comprises at least one of trifluoroacetic anhydride, difluoroacetic anhydride, tetrafluorophthalic anhydride, 4-fluorophthalic anhydride, tetrafluorosuccinic anhydride, heptafluorobutyric anhydride, hexafluoroglutaric anhydride, 4,5-difluorophthalic anhydride, perfluoropropionic anhydride, 4-trifluoromethylbenzoic anhydride, 3,6-difluorophthalic anhydride, 2,3,4,5,6-pentafluorobenzoic anhydride, or difluoromaleic anhydride.

19. The electronic device according to claim 13, wherein the positive current collector comprises a first element; the first element comprises at least one of silicon, copper, manganese, iron, zinc, magnesium, titanium, or vanadium; and
based on a mass of the positive current collector, a mass percent of the first element is C %, and 0<C<2.

20. The electronic device according to claim 19, wherein 0<C/A<1.5.
